(19) United States
(12) Patent Application Publication
(10) Pub. No.: US 2014/0164086 A1
(43) Pub. Date: Jun. 12, 2014

(54) SYSTEMS AND METHODS FOR ASSISTING AND INCENTIVIZING CONSUMERS

(71) Applicants: Ben M. COFFMAN, Reston, VA (US); Dennis S. BRENNAN, Pleasanton, CA (US); Richard S. JUST, Berkeley, CA (US); Joseph O'BRIEN, San Francisco, CA (US); Katharine Anne SHEA, Providence, RI (US); Bryan FEARSON, Herndon, VA (US); Timothy J. AUSTEN, Manassas, VA (US); Shaun WEBB, San Francisco, CA (US)

(72) Inventors: Ben M. COFFMAN, Reston, VA (US); Dennis S. BRENNAN, Pleasanton, CA (US); Richard S. JUST, Berkeley, CA (US); Joseph O'BRIEN, San Francisco, CA (US); Katharine Anne SHEA, Providence, RI (US); Bryan FEARSON, Herndon, VA (US); Timothy J. AUSTEN, Manassas, VA (US); Shaun WEBB, San Francisco, CA (US)

(73) Assignee: Capital One Financial Corporation, McLean, VA (US)

(21) Appl. No.: 14/078,965

(22) Filed: Nov. 13, 2013

Related U.S. Application Data
(60) Provisional application No. 61/736,297, filed on Dec. 12, 2012.

(51) Int. Cl. G06Q 30/02

(52) U.S. Cl. CPC G06Q 30/0215
USPC 705/14.17

(57) ABSTRACT

Systems and processes are disclosed for assisting and incentivizing a user to save money by avoiding impulsive purchases. In certain embodiments, disclosed embodiments may include mechanisms to receive a user-defined goal for saving money and to receive item identifying information relating to an item not purchased by the user in accomplishing the goal. The disclosed embodiments also include mechanisms that determine the price of the item based on the identifying information and determine the amount of savings based on the price of the item. The disclosed embodiments may also be configured to determine and offer a reward to the user based on the amount of savings and to provide to the user a history record of one or more items not purchased in accomplishing the user's goal.

### PRIORITY CLAIM

This disclosure claims priority under 35 U.S.C. §119 to U.S. provisional patent application No. 61/736,297, filed on Dec. 12, 2012, and entitled “Systems and Methods for Assisting and Incentivizing Consumers.” The aforementioned application is incorporated herein by reference in its entirety.

### FIELD

The disclosed embodiments generally relate to financial systems, and more particularly, to systems, processes, and computer programs for assisting and incentivizing users to save money.

Impulsive purchase is pervasive in the marketplace today. Contemporary marketing innovations such as 24-hour retailing, cash machines, various promotional activities, instant cash, and installment payment system, etc. have made it easier for the consumers to operate in the marketplace than ever before. The impulsive purchase phenomena are more manifest in malls or supermarkets than on the Internet, because a consumer can simply grab a product, buy it, and have immediate possession of it.

The impulsive purchase, however, is the destroyer of budgets, which may cause the consumers to lose their ability to buy daily necessities. Even worse, impulsive buying may cause the consumers to default on their credit cards, which may unfortunately lead to declaration of consumer bankruptcies. The consumers often regret about the purchase and wish that the money would have been spent somewhere else. But no matter how good a consumer is at saving and living frugally, sometimes it can be hard to resist the impulsive purchase.

### SUMMARY

Systems and methods for providing money saving processes are described. In certain embodiments, systems, methods and computer programs are disclosed for providing mechanisms that assist and incentivize a consumer to avoid impulsive purchase and save money. Disclosed embodiments include mechanisms that receive a savings goal that may be a user-defined goal for saving money. The disclosed embodiments may also be configured to receive information identifying one or more items that were not purchased by the user in accomplishing the savings goal. The disclosed embodiments may be also configured to determine the price of the identified one or more items based on the received identifying information. The disclosed embodiments may further be configured to calculate an amount of savings for the user based on the determined price of the one or more items and suggest a reward to the user based on the amount of savings. The disclosed embodiments may also be configured to provide to the user a record of the one or more items not purchased in accomplishing the savings goal.

Consistent with some disclosed embodiments, tangible computer-readable storage media may store program instructions that are executable by one or more processors to implement any of the processes disclosed herein.

It is to be understood that both the foregoing general description and the following detailed description are exemplary and explanatory only, and are not restrictive of the disclosed embodiments.

### BRIEF DESCRIPTION OF THE DRAWINGS

The accompanying drawings, which are incorporated in and constitute a part of this specification, illustrate various embodiments and aspects of the disclosed embodiments, and together with the description, serve to explain the principles of the disclosed embodiments.

FIG. 1 is diagram of an exemplary system that may be used to implement disclosed embodiments.

FIG. 2 is an exemplary process flow for assisting and incentivizing a user to save money consistent with the disclosed embodiments.

FIG. 3 is a screenshot of exemplary interface screen for receiving identifying information associated with an item not purchased consistent with the disclosed embodiments.

FIG. 4 is a screenshot of exemplary interface screen for detecting the location of the user consistent with the disclosed embodiments.

FIG. 5 is a screenshot of exemplary interface screen for suggesting an option of spending a portion of the saved money as a reward consistent with the disclosed embodiments.

FIGS. 6 and 7 show exemplary interfaces relating to SaveyPig history records consistent with certain disclosed embodiments.

FIG. 8 shows a diagram of an exemplary data structure storing information for SaveyPig accounts consistent with certain disclosed embodiments.

### DESCRIPTION OF THE EMBODIMENTS

It is to be understood that the following detailed description is exemplary and explanatory only and is not restrictive of disclosed embodiments. For example, steps or processes disclosed herein are not limited to being performed in the order described, but may be performed in any order, and that some steps may be omitted, consistent with the disclosed embodiments.

Reference will now be made in detail to exemplary embodiments, examples of which are illustrated in the accompanying drawings and disclosed herein. Wherever convenient, the same reference numbers may be used in the drawings and the following description to refer to the same or similar parts. Also, similarly named elements may perform similar functions and may be similarly designed. Numerous details are set forth to provide an understanding of the embodiments described herein. In some cases, the embodiments may be practiced without these details. In other instances, well-known techniques and/or components may not be described in detail to avoid obscuring described embodiments. While several exemplary embodiments and features are described herein, modifications, adaptations, and other implementations may be possible, without departing from the spirit and scope of the disclosure. Accordingly, the following detailed description does not limit the disclosure. Instead, the proper scope of the disclosure is defined by the appended claims.

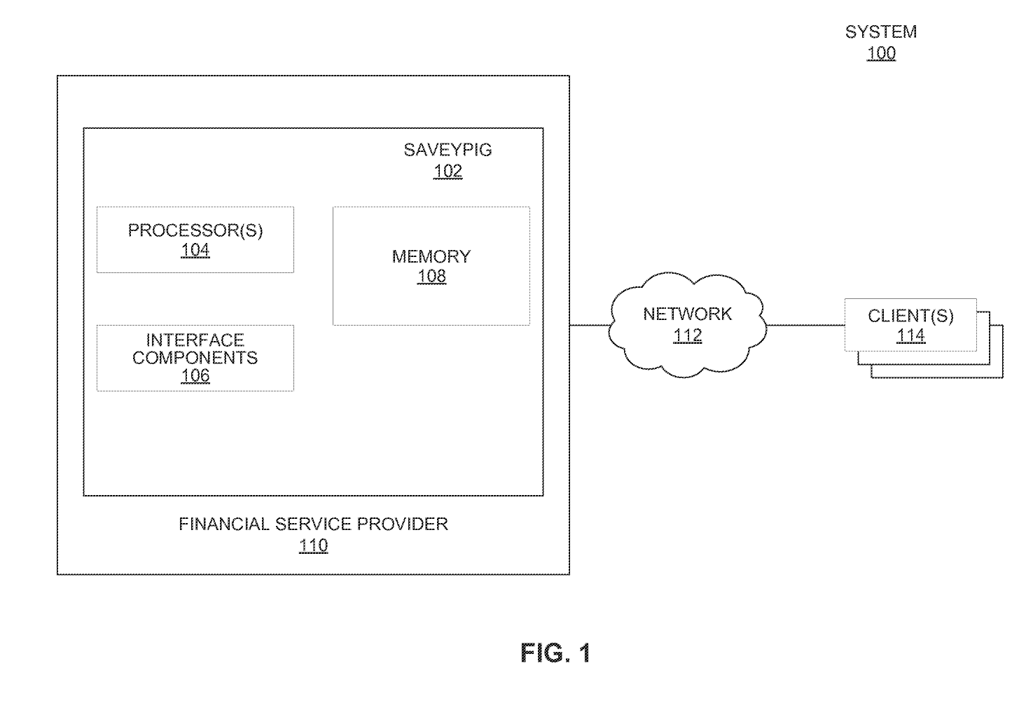

FIG. 1 shows an exemplary system 100 configured to perform one or more processes consistent with the disclosed embodiments. In certain aspects, one or more components of system 100 may be configured to execute one or more software processes to provide one or more aspects of the disclosed embodiments. The components and arrangement shown in FIG. 1 are not intended to be limiting to the disclosed embodiments as the components used to implement certain disclosed processes and features may vary.

In accordance with disclosed embodiments, system 100 may include financial service provider 110, SaveyPig 102, network 112, and one or more clients 114. System 100 may include other components to provide, collect, process, and transmit information consistent with the disclosed embodiments.

SaveyPig 102 may be a computer-based system including computer system components, such as one or more servers, desktop computers, workstations, memory devices, and/or internal network(s) connecting the components. In some embodiments, SaveyPig 102 may be a server that includes one or more processor(s) 104, memory devices, such as memory 108, and interface components 106. SaveyPig 102 may be a single server or may be configured as a distributed computer system including multiple servers or computers that interoperate to perform one or more of the processes and functionalities associated with the disclosed embodiments. In certain embodiments, a SaveyPig server may be implemented as software located on a single physical processing device, or may be multiple software server programs stored on the same or multiple memory devices in a distributed manner.

In certain embodiments, SaveyPig 102 may be a server that is associated with financial service provider 110. Financial service provider 110 may represent, for example, a bank, a merchant, a credit card provider, or any other entity that provides financial services to customers. In some aspects, financial service provider 110 may be an institution where a consumer has a bank account with, and assist the consumer to handle his/her financial transactions. In other aspects, the functionalities performed by SaveyPig 102 as disclosed herein may be software that is executed by one or more processors associated with financial service provider 110. That is, instead of being computer-based system with hardware and software, SaveyPig 102 may represent software instructions stored in a memory (without hardware components) that are executed by a processor associated with financial service provider 110.

Processor(s) 104 may be one or more known processing devices, such as a microprocessor from the Pentium™ family manufactured by Intel™ or the Turion™ family manufactured by AMD™. Processor(s) 104 may include a single core or multiple core processor system that provides the ability to perform parallel processes simultaneously. For example, processor(s) 104 may be a single core processor that is configured with virtual processing technologies known to those skilled in the art. In some embodiments, processor(s) 104 may use logical processors to simultaneously execute and control multiple processes. Processor(s) 104 may implement virtual machine technologies, or other similar known technologies to provide the ability to execute, control, run, manipulate, store, etc. multiple software processes, applications, programs, etc. In other embodiments, processor(s) 104 may include a multiple-core processor arrangement (e.g., dual or quad core) that is configured to provide parallel processing functionalities to allow SaveyPig 102 to execute multiple processes simultaneously. One of ordinary skill in the art would understand that other types of processor arrangements could be implemented that provide for the capabilities disclosed herein.

SaveyPig 102 may also include one or more storage devices configured to store instructions used by processor(s) 104 (or other components) to perform certain functions related to the disclosed embodiments. In one example, SaveyPig 102 may include memory 108 that includes instructions to enable processor(s) 104 to execute one or more applications, such as server applications, network communication processes, or any other type of application or software available on computer systems. Alternatively, the instructions, application programs, etc. may be stored in an external storage or available from a memory over a network. The one or more storage devices may be a volatile or non-volatile, magnetic, semiconductor, tape, optical, removable, non-removable, or other type of storage device or tangible computer-readable medium.

Methods, systems, and computer programs consistent with the disclosed embodiments are not limited to separate programs or computers configured to perform dedicated tasks. For example, SaveyPig 102 may include a memory that may include one or more programs to perform one or more functions for multiple user display control. Moreover, processor(s) 104 may execute one or more programs located remotely from system 100. For example, system 100 may access one or more remote programs, that, when executed, perform functions related to disclosed embodiments. Memory 108 may include one or more memory devices that store data and instructions used to perform one or more features of the disclosed embodiments. Memory 108 may also include any combination of one or more databases controlled by memory controller devices (e.g., server(s), etc.) or software, such as document management systems, Microsoft SQL databases, SharePoint databases, Oracle™ databases, Sybase™ databases, or other relational databases.

SaveyPig 102 may also be communicatively connected to one or more memory devices (e.g., databases (not shown)) locally or through a network. The remote memory devices may be configured to store information and may be accessed and/or managed by SaveyPig 102. By way of example, the remote memory devices may be document management systems, Microsoft SQL database, SharePoint databases, Oracle™ databases, Sybase™ databases, or other relational databases. Systems, processes, computer programs, and tangible computer-readable medium of disclosed embodiments, however, are not limited to separate databases or even to the use of a database.

SaveyPig 102 may also include one or more I/O devices that may comprise one or more interfaces for receiving signals or input from input devices and providing signals or output to one or more output devices that allow data to be received and/or transmitted by SaveyPig 102. For example, SaveyPig 102 may include interface components 106 that may provide interfaces to one or more input devices, such as one or more keyboards, mouse devices, and the like, that enable SaveyPig to receive data from one or more users such as client(s) 114. Furthermore, interface components 106 may include components configured to send and receive information between components of SaveyPig 102 or external to SaveyPig 102, such as network 112.

Network 112 may be any type of network that provides communications, exchanges information, and/or facilitates the exchange of information between SaveyPig 102 and client(s) 114. In one embodiment, network 112 may be the Internet, a Local Area Network, or other suitable connection(s) that enables system 100 to send and receive information between the components of system 100.

Client(s) 114 may be one or more computer systems. For example, client(s) 114 may include a general purpose or notebook computer, a mobile device with computing ability, a server, a desktop computer, tablet, or any combination of these computers and/or affiliated components. For example, client(s) 114 may be a smartphone, which is adopted to perform all the functions consistent with the disclosed embodiments. In some embodiments, each client may be a computer system or device that is operated by a user who is a customer or a potential customer of financial service provider 110. Client(s) 114 may be configured with storage that stores one or more operating systems that perform known operating system functions when executed by one or more processors. By way of example, the operating systems may include Microsoft Windows™, Unix™, Linux™, Apple™ Computers type operating systems, Personal Digital Assistant (PDA) type operating systems, such as Microsoft CE™, or other types of operating systems. Accordingly, embodiments of the disclosed invention will operate and function with computer systems running any type of operating system. Client(s) 114 may also include communication software that, when executed by a processor, provides communications with network 112, such as Web browser software, tablet or smart hand held device networking software, etc.

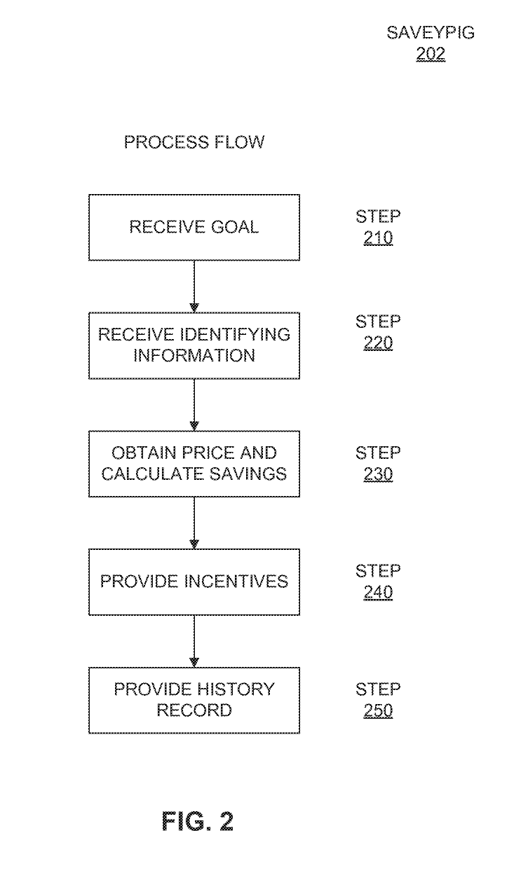

FIG. 2 illustrates an exemplary process flow for assisting and incentivizing a user to save money consistent with the disclosed embodiments. The sequence and arrangement of the process flow shown in FIG. 2 is exemplary. Disclosed embodiments may perform one or more of the processes shown in FIG. 2 in other sequences, and additional or fewer processes may be included in the user incentivizing process of FIG. 2.

In certain embodiments, SaveyPig 202 (SaveyPig 202 may be configured to perform the same or similar functions as SaveyPig 102) may be configured to perform incentivizing processes including receiving a goal set by a user associated with client 114 for saving money (some aspects are discussed in greater detail at step 210), receiving at least one piece of information identifying one or more items the user avoid buying in accomplishing the goal (some aspects are discussed in greater detail at step 220), obtaining the price of the one or more items and calculating the amount of money saved (some aspects are discussed in greater detail at step 230), providing incentives to the user for saving money (some aspects are discussed in greater detail at step 240), and providing a record of the items the user did not buy (some aspects are discussed in greater detail at step 250).

In certain embodiments, SaveyPig 202 may execute software that provides a SaveyPig application to client 114 for providing SaveyPig incentivizing processes consistent with the disclosed embodiments. In one aspect, SaveyPig 202 may send a SaveyPig mobile application to client 114 (which may be a mobile device). Client 114 may be configured to receive and store the SaveyPig mobile application for execution to perform certain processes consistent with certain disclosed embodiments. Client 114 may execute the SaveyPig application in response to a user input (e.g., selecting an icon representing the SaveyPig application on their mobile devices). Other manners to initiate execution of the SaveyPig application may also be implemented depending on the type of device that client 114 may be.

In certain embodiments, SaveyPig 202 may be configured to execute software that configures a SaveyPig account for a user. The SaveyPig account may be stored in a memory and may be linked to one or more financial service accounts associated with the user and provided by financial service provider 110.

To incentivize the user to save money by avoiding an impulsive purchase, client 114 may be configured to execute the SaveyPig application that allows the user to set up a goal that is provided to SaveyPig 202 (e.g., step 210). For example, client 114 may be configured to execute, via the SaveyPig application, software that generates a configuration interface with options, queries, etc. that is displayed by client 114. In one aspect, the configuration interface may allow the user to set up one or more goals for saving a certain amount of money by avoiding impulsive purchases during a certain period of time. In certain aspects, SaveyPig 202 may be configured to generate and send to client 114 the configuration interface based on a request from client 114. Client 114 may perform known processes for receiving the configuration interface from SaveyPig 202 and displaying the interface on a display on client 114.

Further, in certain aspects, client 114 may be configured to send a request (via for example a user input on client 114) to configure a SaveyPig account with SaveyPig 202. SaveyPig 202 may receive the client request, and based on the request, generate and send the configuration interface to client 114. Client device 114 may receive input from the user based on the request(s) in the configuration interface and send the user input to SaveyPig 202.

Client 114 may also be configured to execute the SaveyPig application such that the software generates an interface to allow the user to input and send to SaveyPig 202 one or more pieces of information identifying one or more items that the user did not purchase in accomplishing his/her goal (e.g., step 220). In some embodiments, the SaveyPig application may be configured to generate an item interface that enables the user to input to client device 114 identifying information associated with an item not purchased. The item interface may include an option for the user to input the item identifying information and to send the information. In response to the user input, client device 114 may generate a message that sends the user's inputted identifying information to SaveyPig 202. In other embodiments, client device 114 may be configured to store the user's inputted identifying information in memory and send the information to SaveyPig 202 at a later time. For example, client device 114 may receive a set of item identifying information for different items over a period of time, store the received information, and send the stored information collectively to SaveyPig 202. SaveyPig 202 may also be configured to request item identifying information from client 114. In response to the request, client device 114 may send the item identifying information.

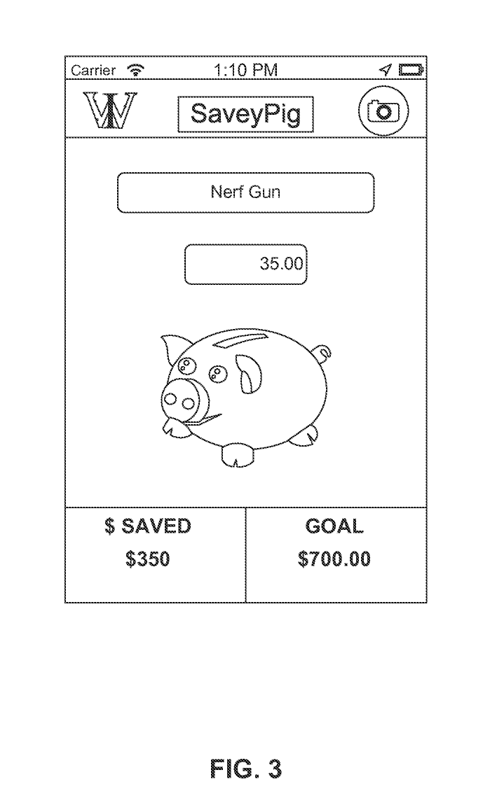

In certain embodiments, the SaveyPig application may allow the user to input item identifying information in different formats. For example, the user may record an item via a medium such as, for example, photo, video, audio, or a picture drawn by the user using drawing software provided by the SaveyPig application or another mobile application, etc. The user may also input text information describing the item (e.g., description of item, date of forgone purchase, the price of the item, etc.). In certain aspects, the user may input the price of the item together with a record of the item in a different format (e.g., picture, video, etc.). Client 114, via the SaveyPig application or otherwise, may send the item information (e.g., recorded medium and item's price) to SaveyPig 202. In certain embodiments, client device 114 via the SaveyPig application may allow the user to include in the item identifying information such as the item's barcode. FIG. 3 shows an exemplary interface that may be provided by the SaveyPig application executing on client 114 that allows the user to enter the name of an item and its price.

Based on the item identifying information associated with the one or more items, SaveyPig 202 may execute software that determines the price of the item(s) and calculates the amount of money saved by the user by not purchasing the item(s) (e.g., step 230).

In some embodiments, SaveyPig 202 may configure the user's SaveyPig account to have a saved amount field set to zero. SaveyPig 202 may adjust the saved amount for the user's SaveyPig account based on received item identifying information provided by client 114. Thus, for example, when the user sends item identifying information relating to an item not purchased, SaveyPig 202 may determine the price of the item and add that amount to the saved amount for the user's SaveyPig account. For example, when SaveyPig 202 receives from client device 114 the item identifying information including the item's price, SaveyPig 202 may use the price information to determine a value to add a saved amount field for the user's SaveyPig account.

In certain embodiments, SaveyPig 202 may execute software that determines the price of an item included in item identifying information received from client 114. For example, SaveyPig 202 may be configured to execute software that performs image recognition and/or scanning processes that identifies a purchase price of an item based on image data included in an image of the item provided by client 114. For instance, SaveyPig 202 may process an image of an item's barcode or SKU number included in the received item identifying information to determine the barcode number. Based on the barcode, SaveyPig 202 may perform processes that search one or more sources of information corresponding to the barcode or SKU data to determine the item's price. Other information may be used to perform this process, such as information regarding the name of the item, the merchant that was selling the product, the manufacturer or supplier of the item, etc.

As an example, SaveyPig 202 may request from another server (e.g., a supplier's website, computer, etc.) the price of an item based on image processed data obtained from processing the image of an item. Alternatively, SaveyPig 202 may send the image of an item and/or the item's SKU number to another server remote from SaveyPig 202 to retrieve the price of the item. For instance, SaveyPig 202 may send a copy of an image of an item to a third party server that performs processes for determining the price of the item. The third party server may send the price of the item to SaveyPig 202. In certain aspects, the third party server may charge a fee for providing the service of providing the price of items requested by SaveyPig 202.

In other embodiments, SaveyPig 202 may be configured to execute software that transfers certain monetary amounts from one user account to another to reflect the savings obtained by the user by not purchasing an item. For example, SaveyPig 202 may transfer a saved amount of monetary funds from the user's checking account into the user's saving account. Thus, in embodiments where the user has checking and savings accounts with financial service provider 110, SaveyPig 202 may determine when a saving event occurs (e.g., the user records and sends via client 114 item identifying information to SaveyPig 202), SaveyPig 202 may transfer the determined amount of money saved to the user's saving account.

Other mechanisms for reflecting savings may also be implemented by the disclosed embodiments. For example, SaveyPig 202 may execute software that applies the determined savings amount from the user's checking or savings account to a credit card balance that may or may not be provided by financial service provider 110. In such embodiments, the SaveyPig application executed by client 114 may generate an interface that allows the user to configure their SaveyPig account such that the user can select how determined savings can be applied. For instance, via the SaveyPig application, the user may allow SaveyPig 202 to make payments to other user accounts based on the amount of savings determined during the SaveyPig processes. Payments may include payments to a credit card account, to merchant accounts, to service provider accounts (e.g., utility bills, etc.). SaveyPig 202 may be configured to provide bill payment functionalities including, for example, using user's financial service account provided by financial service provider 110 to make certain payments.

The SaveyPig processes consistent with the disclosed embodiments may also enable SaveyPig 202 to provide a reward for incentivizing the user to save money (e.g., step 240). For instance, the SaveyPig application executed by client 114 may generate an interface that provides a suggestion to the user to spend a portion of the money saved (e.g., a fix amount or a certain percent) by avoiding a purchase of an item. In some aspects, the SaveyPig application may enable the user to set the amount of money that the user may spend in rewarding himself/herself (e.g., a maximum reward amount, such as 20% of the price of the item that the user avoided purchasing and recorded using the SaveyPig application). In other aspects, SaveyPig 202 may execute software processes that determine and store in a reward field of the user's SaveyPig account a reward amount set by the user. For example, SaveyPig 202 may determine based on one or more determined parameters (e.g., user provided parameters) whether to transfer a reward amount of monetary funds from a user's account (e.g., checking account) to another account (e.g., savings account) or vice versa. Thus, for example, SaveyPig 202 may transfer 20% of an item's purchase price identified in the identifying information provided by client 114 from one account to another. SaveyPig 202 may generate and send a notification to client 114 indicating that the transfer has been performed. The notification may include information informing the user that the amount is available for use as a reward for the user not purchasing the identified item.

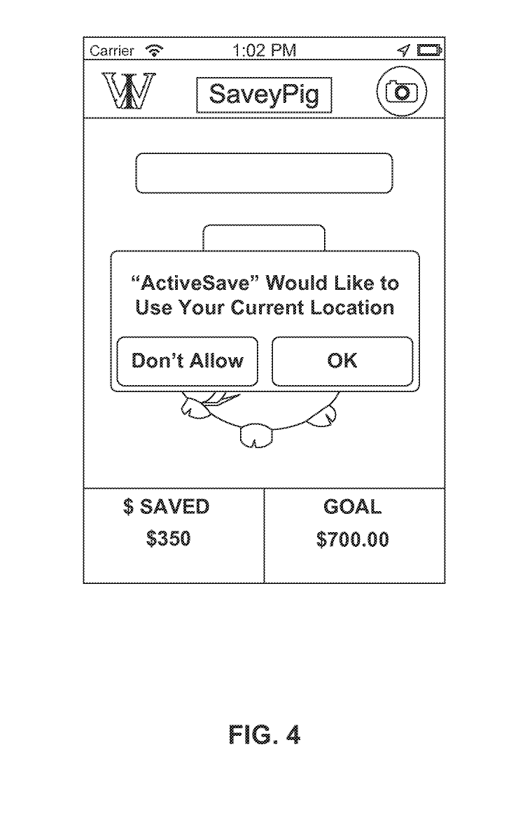

In other embodiments, the SaveyPig application executed by client 114 may be configured to generate an interface displaying one or more options regarding how to reward the user for saving money. For example, FIG. 4 shows an exemplary interface that may be provided by the SaveyPig application on client 114. As shown, the SaveyPig application may request that the user allow the SaveyPig application to use the user's (client 114) current location. Client 114 may include software that enables it to determine the geographical location of client 114, such as GPS processes. The SaveyPig application may receive geographic location information from the GPS processes to perform functions consistent with this embodiment. Based on the user's (client 114) current location (assuming the user allows such information to be used), the SaveyPig application may be configured to provide one or more options for spending a SaveyPig reward in the neighborhood of the detected location.

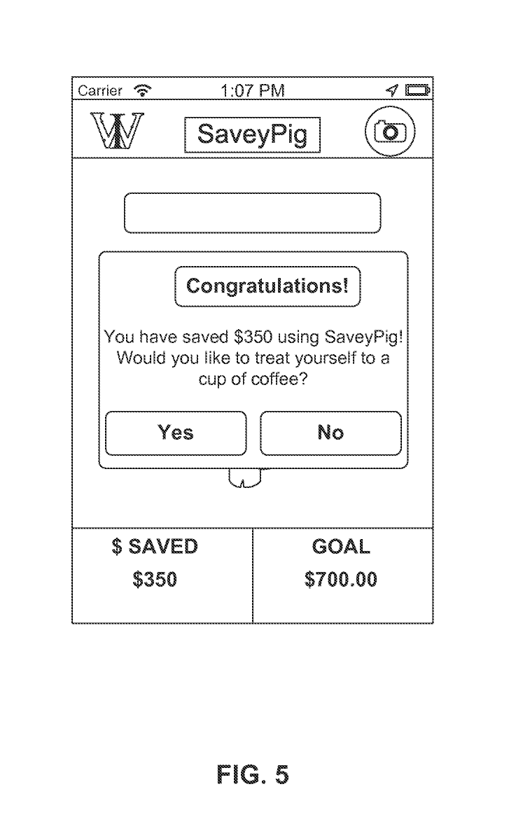

FIG. 5 shows an exemplary interface that may be provided by the SaveyPig application consistent with certain embodiments. As shown in FIG. 5, the SaveyPig application may determine that a certain reward location, such as a merchant, retailer, etc. (e.g., a coffee shop), is within a determined distance of the current location of the user (client 114). The determined distance may be set by the user via the SaveyPig application when the SaveyPig account is configured or at any later time via corresponding interface(s) provided by the SaveyPig application (e.g., the user selects a quarter mile range, 300 feet range, etc.). SaveyPig 202 may also be configured to determine one or more reward locations based on the current geographic location of client 114, which may be provided by client 114 to SaveyPig 202 periodically or on request.

The SaveyPig application may generate an interface that is displayed to the user via client 114 that includes a personalized message informing the user of a reward location nearby and asking the user whether they wish to purchase an item or service at that reward location. For example, as shown in FIG. 5, the SaveyPig application may present an interface that asks the user whether he/she would like to buy a cup of coffee to reward his/her efforts of saving money by not purchasing an item. If the user accepts the suggestion, the SaveyPig application may be configured to provide one or more ways for the user to use the portion of the money saved. For example, the SaveyPig application may generate an interface that provides one or more options for the user to use the saved amount, such as a coupon, a voucher, or a pre-paid gift card, etc. for purchasing an item or service.

In certain embodiments, the SaveyPig application may be configured to generate and provide for display the reward interface(s) in response to the user's recording item identifying information associated with an item that was not purchased. In one aspect, the SaveyPig application may identify as a trigger event when the user completes a SaveyPig savings event, such as when a user inputs item identifying information to client 114. In other aspects, SaveyPig 202 may execute software that identifies a SaveyPig savings event, such as when SaveyPig 202 receives from client 114 item identifying information and determines a savings amount that is updated in the user's SaveyPig account.

In other embodiments, the SaveyPig application may be configured to determine a frequency of rewards offered to the user for saving money. The user may be allowed to configure the frequency period for such aspects via the SaveyPig application. In another embodiment, the SaveyPig application may be configured to determine a fixed number of times the reward should be given, which may be over a certain period of time or not (e.g., five times a month or five times total). In other aspects, the SaveyPig application may be configured to generate the interface to allow the user to receive a reward once the user's SaveyPig account reaches a certain percentage of a savings goal (e.g., ten percent, thirty percent, fifty percent, and etc.).

In certain aspects, SaveyPig 202 may be configured to execute software that determines when the user reaches his/her SaveyPig savings goal and to provide a history of the SaveyPig savings process for display to the user (e.g., step 250). In other aspects, the SaveyPig application executed on client device 114 may perform the same type of processes. For instance, SaveyPig 202 (or the SaveyPig application) may determine by checking the savings goal for the user's SaveyPig account (or via other mechanisms) that the user's SaveyPig savings goal was reached or exceed. SaveyPig 202 or the SaveyPig application may be configured to periodically and automatically check the user's SaveyPig savings goal to make this determination. Based on the determination that the savings goal was reached, SaveyPig 202 or the SaveyPig application may execute a SaveyPig history compilation process that collects information reflecting the items and purchase amounts of the items that the user did not purchase during the SaveyPig savings process. The SaveyPig savings process may include a period beginning when the user's SaveyPig account includes a zero amount for the savings amount and concludes when the user's SaveyPig account includes a savings amount that meets or exceeds the SaveyPig savings goal for the user.

For example, SaveyPig 202 may be configured to store the item identifying information provided by client 114 during the SaveyPig savings process for the user. When the SaveyPig savings goal is reached, SaveyPig 202 may access the item identifying information for the user and generate a historical file including information associated with the item(s) that the user did not purchase during the SaveyPig savings process. Thus, for example, SaveyPig 202 may generate a SaveyPig history record including images of the items not purchased and inputted to client device 114, and sent to SaveyPig 202 by client device 114. The SaveyPig history record may also include purchase price information for each item, timestamp information relating to the item, and any other information. In some aspects, the items in the SaveyPig history record may be arranged in a timeline manner (e.g., item images and/or information arranged in a timeline sequence). In other aspects, the SaveyPig history record may include information reflecting the items arranged according to their respective price. SaveyPig 202 may send the generated SaveyPig history record to client 114 for display. In certain aspects, the SaveyPig application may generate an interface that includes the SaveyPig history record. Alternatively, SaveyPig 202 may send the SaveyPig history record using other known delivery mechanisms, such as e-mail, SMS, social networking site file uploads, etc.

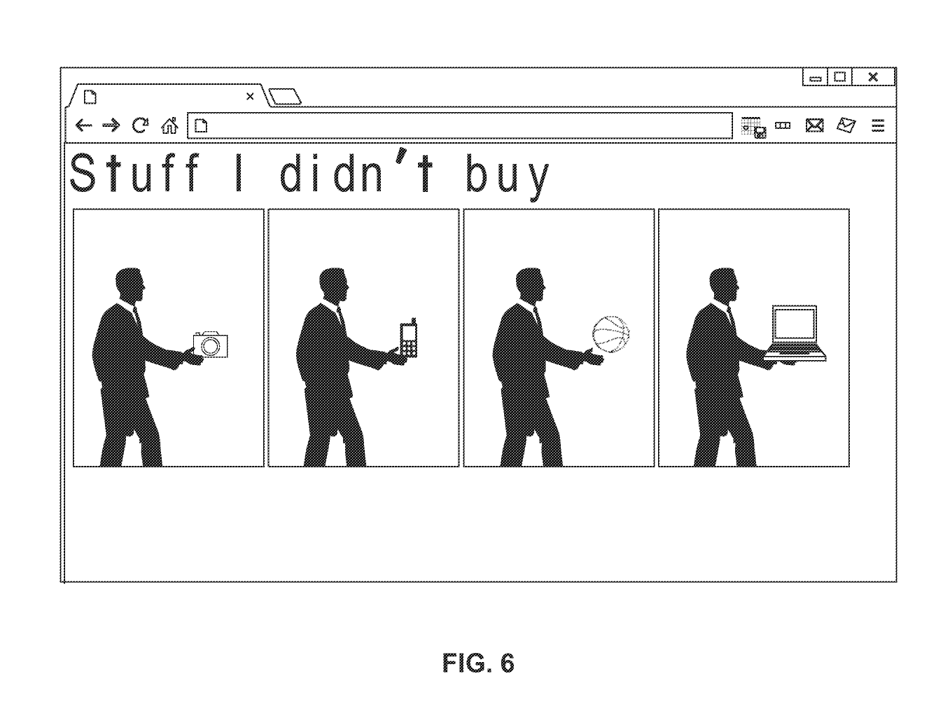

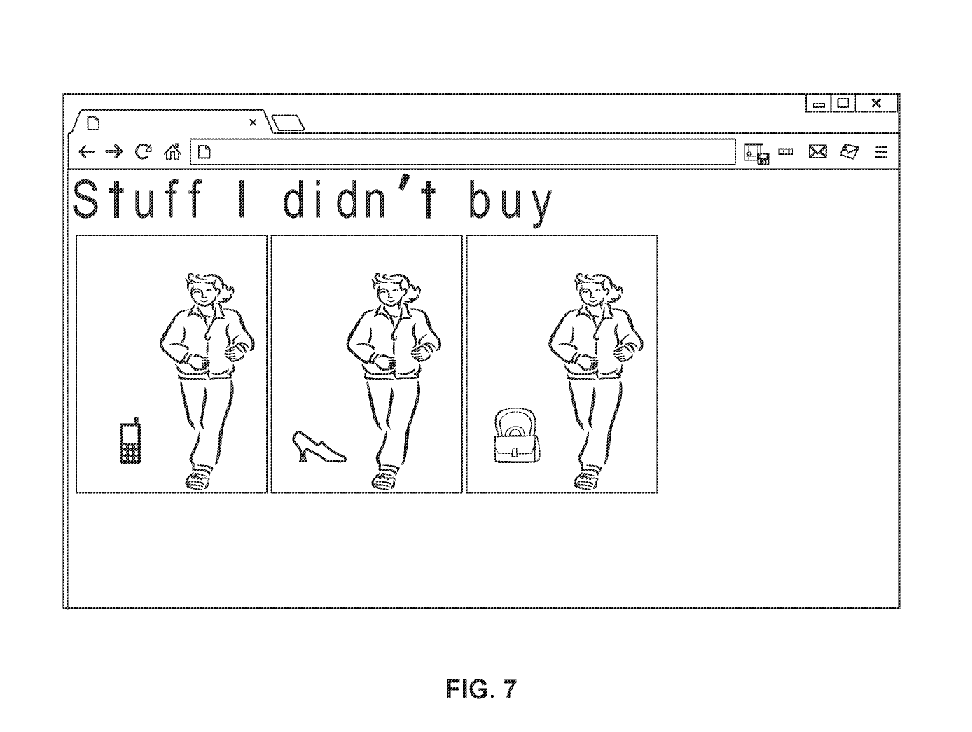

In certain embodiments, SaveyPig 202 may generate and store the SaveyPig history record in a memory that is accessible by client 114 or the user via another device. For example, SaveyPig 202 may store the SaveyPig history record in a file that is accessible via a website (e.g., a website provided by financial service provider 110). SaveyPig 202 may send a link to the location of the SaveyPig history record to client 114 that the user may select to access and view the record. FIGS. 6 and 7 show exemplary interfaces that include information that may be provided in exemplary SaveyPig history records. In some embodiments, a user may take a photo of the items (i.e., a camera, a cell phone, a basketball, and a laptop) that the user did not purchase in accomplishing the savings goal and send them (e.g., via client 114) to SaveyPig 102. Additionally or alternatively, the user may provide a description of the unpurchased item to SaveyPig 102. As shown in FIG. 6, those items may appear in the SaveyPig history record accessible via the website. For example, the photos the user took or information associated with the pictured items may be stored to SaveyPig history record. Similarly, the items (i.e., a cell phone, a pair of shoes, and a bag) shown in FIG. 7 may also be provided to and stored in the SaveyPig history record. The SaveyPig application executed by client 114 may provide an interface that allows the user to configure how the SaveyPig history record is to be presented by client 114. For example, the SaveyPig application may present via an interface one or more options for the user to set an order of the items not purchased to be arranged in the SaveyPig history record.

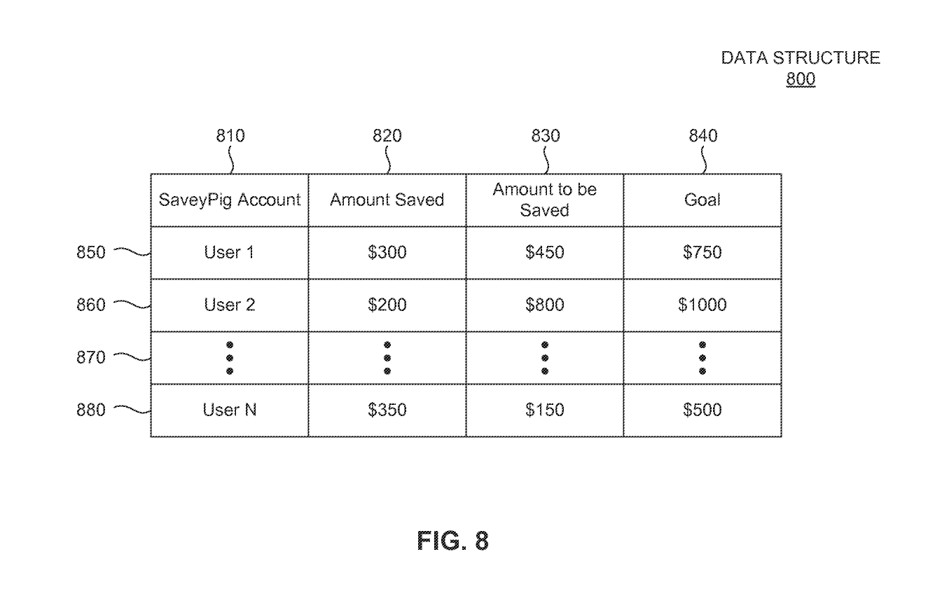

FIG. 8 shows a diagram of an exemplary data structure 800 storing information for SaveyPig accounts for a number of users. In certain aspects, SaveyPig 202 may generate, store, and update data structure 800 (or a similar structure), consistent with certain disclosed embodiments. For example, information associated with an individual user of SaveyPig 102 (e.g., User 1, User 2, . . . , and User N) may be stored in separate rows (e.g., rows 850, 860, 870, and 880) of the data structure 800. Information concerning one or more types of information associated with SaveyPig 102 and/or users of SaveyPig 102 may also be stored in separate columns of data structure 800. For example, information concerning the identify of separate users of SaveyPig 102 may be stored in column 810 of data structure 800. Information concerning the amount that the separate users of SaveyPig 102 have saved may be stored in column 820 of the data structure 800. In some embodiments, information concerning the amount to be saved by the separate users of SaveyPig 102 in accomplishing savings goals may be stored in column 830 of the data structure 800. Finally, information regarding users' savings goals may be stored in the data structure at column 840. For example, the data stored at column 840, row 850 (i.e., data element G1) may indicate a User 1 savings goal of $750. One of skill in the art would understand that the above description of data structure 800 is provided for exemplary purposes only, and that additional or fewer types of information may be stored in the data structure 800, consistent with disclosed embodiments. For example, data structure 800 may also store data regarding item(s) a user chose not to purchase, rewards history (see, e.g., the discussion with respect to FIG. 5), user preferences, etc., as well as other data associated with disclosed embodiments, including those discussed further below.

In some embodiments, SaveyPig 202 and the SaveyPig application may be configured to perform other functions consistent with the disclosed embodiments. For example, the SaveyPig application may be configured to generate an interface that allows the user to rate his/her experience relating to saving money using one or more processes consistent with the disclosed embodiments. In some embodiments, SaveyPig 202 and/or the SaveyPig application may be configured to provide interfaces that are displayed by client 114 that allow the user to share his/her experiences via social networking sites or other broadcast media.

As another example, to assist the user to handle his/her financial matters, and to make the saving process more convenient, SaveyPig 202 may be configured to provide mechanisms that allow a user to open a bank account with financial service provider 110. In some embodiments, SaveyPig 202 may be configured to provide some commercial information relating to opening a new bank account with financial service provider 110. In other embodiments, SaveyPig 202 may be configured to provide some incentives for opening the new bank account, such as, for example, giving a gift card, depositing some reward directly into the newly opened bank account, or the like. In such embodiments, SaveyPig 202 may be configured to generate one or more interfaces that are provided to client 114 for display to the user. The SaveyPig application may also generate and display such interfaces.

As another example, SaveyPig 202 may be configured to perform gamification functions. For example, SaveyPig 202 may determine and generate incentives (both virtual and/or real) for rewarding the user for using the SaveyPig application or processes consistent with the SaveyPig savings process. The incentives may include earning status such as, for example, a gold/silver/bronze or superstar/starlet/standing rating associated with the user's SaveyPig account (e.g., percentage of savings goal reached, etc.), or with other financial service accounts. Real and virtual rewards may also be given for sharing the money saving experience via social networking sites and recommending it to other entities or users (e.g., friends, business partners, etc.). A virtual reward may include earning status associations, such as exemplary rating levels. The disclosed embodiments may execute software that may convert virtual rewards to real awards based on the rating level. For example, when SaveyPig 202 or SaveyPig application determines that a user's SaveyPig account has reached a certain virtual reward level, the application may initiate real reward offers (or inform SaveyPig 202 to initiate or provide a real reward offer), such as discounts, monetary transfers, coupons, etc.

The disclosed embodiments may be associated to different types of financial services. Any financial institution that provides financial service accounts to customers may employ systems, methods, and articles of manufacture consistent with certain principles related to the disclosed embodiments. In addition, other types of entities, such as a merchant, retailer, or other type corporate entity that may also employ systems, methods, and articles of manufacture consistent with certain disclosed embodiments.

Furthermore, although aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM. Accordingly, the disclosed embodiments are not limited to the above described examples, but instead are defined by the appended claims in light of their full scope of equivalents.

What is claimed is:

1. A system for providing monetary saving incentives comprising:
a processor; and
a storage device storing instructions that, when executed by the processor, cause the processor to perform operations comprising:
receiving a savings goal input associated with a user;
receiving item identifying information relating to an item that was not purchased by the user in accomplishing the savings goal;
determining the price of item based on the item identifying information;
determining an amount of savings based on the determined price of the item;
determining a reward to the user based on the amount of savings; and
providing a history record including information associated with the item not purchased in accomplishing the savings goal.

2. The system of claim 1, wherein the operations further include creating an account for the user for accomplishing the savings goal, wherein the account is linked to one or more financial service accounts associated with the user.

3. The system of claim 2, wherein the operations further include transferring the amount of savings between the created account and the one or more financial service accounts associated with the user.

4. The system of claim 1, wherein the operations further include providing an interface for the user to set the savings goal, wherein the interface comprises user-selectable options for receiving information associated with the savings goal.

5. The system of claim 1, wherein the item identifying information includes recorded media information.

6. The system of claim 1, wherein determining the reward to the user is determined based on at least one of a current location of the user, a spending limit, or a frequency of the reward.

7. The system of claim 1, wherein the operations further include providing the history record in a timeline format.

8. A method for providing monetary saving incentives comprising:
receiving a savings goal input associated with a user;
receiving item identifying information relating to an item that was not purchased by the user in accomplishing the savings goal;
determining, via one or more processors, the price of item based on the item identifying information;
determining, via the one or more processors, an amount of savings based on the determined price of the item;
determining, via the one or more processors, a reward to the user based on the amount of savings; and
providing a history record including information associated with the item not purchased in accomplishing the savings goal.

9. The method of claim 8, further comprising creating an account for the user for accomplishing the savings goal, wherein the account is linked to one or more financial service accounts associated with the user.

10. The method of claim 9, further comprising transferring the amount of savings between the created account and the one or more financial service accounts associated with the user.

11. The method of claim 8, further comprising providing an interface for the user to set the savings goal, wherein the interface comprises user-selectable options for receiving information associated with the savings goal.

12. The method of claim 4, wherein the item identifying information includes recorded media information.

13. The method of claim 4, wherein determining the reward to the user is determined based on at least one of a current location of the user, a spending limit, or a frequency of the reward.

14. The method of claim 8, wherein the method further comprises providing the history record in a timeline manner.

15. A non-transitory computer readable medium storing instructions that, when executed by a processor, cause the processor to:
receive a savings goal input associated with a user;
receive item identifying information relating to an item that was not purchased by the user in accomplishing the savings goal;
determine the price of item based on the item identifying information;
determine an amount of savings based on the determined price of the item;
determine a reward to the user based on the amount of savings; and
provide a history record including information associated with the item not purchased in accomplishing the savings goal.

16. The medium of claim 15, wherein the instructions further cause the processor to create an account for the user for accomplishing the savings goal, wherein the account is linked to one or more financial service accounts associated with the user.

17. The medium of claim 16, wherein the instructions further cause the processor to transfer the amount of savings between the created account and the one or more financial service accounts associated with the user.

18. The medium of claim 15, wherein the instructions further cause the processor to provide an interface for the user to set the savings goal, wherein the interface comprises user-selectable options for receiving information associated with the savings goal.

19. The medium of claim 15, wherein the item identifying information includes recorded media information.

20. The medium of claim 15, wherein determining the reward to the user is determined based on at least one of a current location of the user, a spending limit, or a frequency of the reward.
